(19) United States
(12) Patent Application Publication
(10) Pub. No.: US 2022/0120130 A1
(43) Pub. Date: Apr. 21, 2022

(54) POWDER COATED METAL DOOR WITH CORE

(71) Applicant: Allmark Door Company, LLC, Springfield, NJ (US)

(72) Inventor: Gilbert Markham, Media, PA (US)

(21) Appl. No.: 17/502,718

(22) Filed: Oct. 15, 2021

Related U.S. Application Data
(60) Provisional application No. 63/092,216, filed on Oct. 15, 2020.
(60) Provisional application No. 63/094,173, filed on Oct. 20, 2020.

(51) Int. Cl. E06B 3/16

(52) U.S. Cl. CPC E06B 3/16

(57) ABSTRACT

A metal door and the method of making a metal door having powder coated, front and back skins, powder coated hinge and lock channels powder coated top and bottom channel and a core positioned within the door assembly.

### RELATED APPLICATIONS

This application claims the benefit of U.S. Provisional Application No. 63/092,216 filed on Oct. 15, 2020, and U.S. Provisional Application No. 63/094,173 filed on Oct. 20, 2020. The entire disclosures of which are hereby incorporated by reference in their entireties.

### TECHNICAL FIELD

This invention relates generally to hollow metal doors that have cores and more particularly to an improved metal door with a core that is resistant to corrosion.

### BACKGROUND OF THE INVENTION

The present invention relates to steel doors and more particularly, to steel doors used in industrial applications. These doors are commonly known as “Hollow Metal Doors” despite often having a core. With these doors, one of the key components can be the core material. There are five standard core types used in hollow metal doors: Honeycomb, Polystyrene, Polyurethane, Steel Stiffened, and Mineral Core.

Honeycomb cores get their name from the honeycomb shaped cardboard that is hardened by special resins. This material is the most used at interior openings and is a heavy-duty, durable core. It can be fire rated up to 3 hours. The insulation value is lower than a foam core, but it can be used at exterior openings if a cost effective solution is desired.

Polystyrene is the first level of insulated door core. The polystyrene is a slab of foam that is placed in the core of the door. Hollow metal doors with this core type are most often used at exterior openings and can be fire rated up to 3 hours. The insulation value is much higher than the honeycomb but lower than the polyurethane.

Polyurethane core is a foam that is injected into the core and expands to fill all the available space within the cavity of the hollow metal door. Polyurethane will have the best insulation value that is higher than both honeycomb and polystyrene. However, a polyurethane door cannot be fire rated.

Steel stiffened hollow metal doors have steel channels that run the full height of the door and are spaced about 6″ O.C. across the width of the door. They are spot welded to the faces and the gaps between the channels is filled with insulation. These doors are often specified at high abuse areas or can be used at openings where sound transmission ratings are a concern.

Mineral Core hollow metal doors can be specified with a temperature rise rating which will require a sheet of mineral board inserted into the door. This material has properties that reduce the heat that is transferred through the door to the non-fire side of the opening. Temperature rise ratings can be 250, 450 or 650 degrees where the lower rating of 250 performs better than the higher ratings. In the event of a fire, this allows building occupants to pass by the opening unharmed by the heat from the fire.

All these doors are generally built from cold rolled steel or galvanneal steel. They are then painted. One of the problems with these doors is that they corrode over time. Steel doors will corrode much more quickly than galvanneal steel, but both corrode. Even with their surfaces painted, these doors will corrode. One of the main causes for the corrosion is the general wear and tear of these doors over time.

Another problem is the lack of treatment to the interior of the door. Since the interior is not regularly exposed to the outside elements the interior is not treated. But, it is susceptible to corrosion. Condensation develops on the interior of the door. It is the result of temperature variances during the day. Most commercial doors are outswing, therefore exposing the top to the elements. Rain, snow and ice have a way to find themselves into the interior of the door through the top. All of this results in the corrosion of the door from the interior as well as the exterior.

### SUMMARY OF THE INVENTION

In general terms, this invention provides a metal door and a method of making a metal door having powder coated, front and back skins, powder coated hinge and lock channels powder coated top and bottom channels and a core positioned within the door outer assembly.

These and other features and advantages of this invention will become more apparent to those skilled in the art from the detailed description of a preferred embodiment. The drawings that accompany the detailed description are described below.

### BRIEF DESCRIPTION OF THE DRAWINGS

FIG. 1 is a perspective view of the interior of the powder coated door of the present invention.

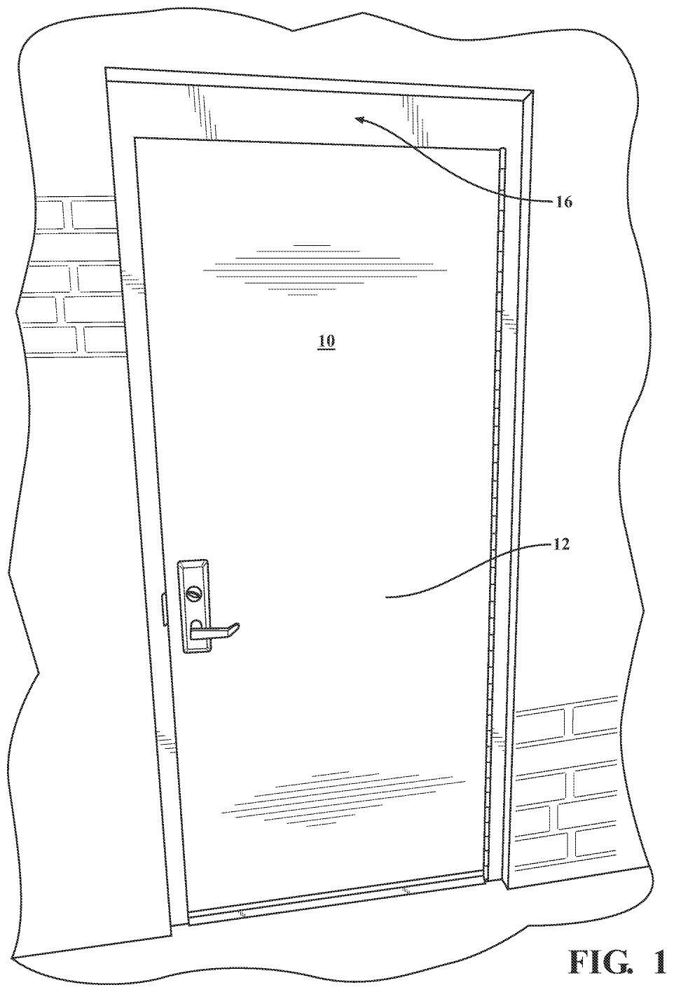

FIG. 2 is a perspective view of the exterior of the powder coated door of the present invention.

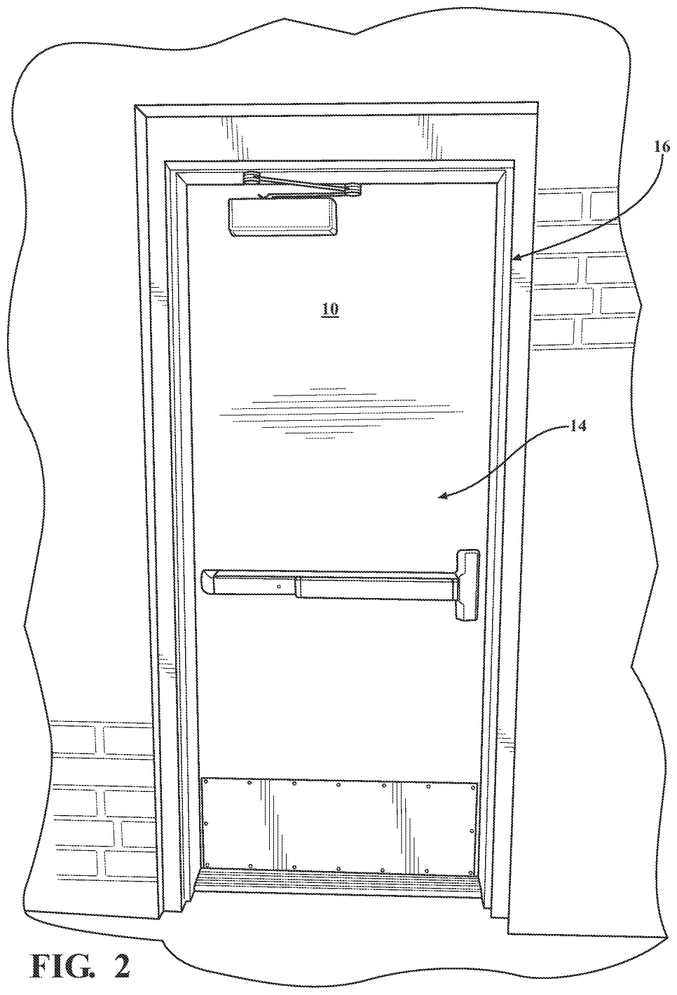

FIG. 3 is an exploded view of the powder coated door of the present invention.

FIG. 4 is a schematic view of the method of making the powder coated door of the present invention.

### DETAILED DESCRIPTION OF A PREFERRED EMBODIMENT

The door of the present invention is shown generally at 10 in the drawings. The door has an exterior side or skin 12 and interior side or skin 14 and is mounted in a frame 16. The door 10 illustrated is only an example of a door that can form a part of the present invention. It should be appreciated that other door styles, such as doors with windows, vents, and double doors could be part of the present invention.

The door 10 is a powder coated door with a core. The parts of the door 10 are powder coated and after the powder coating is complete, the door 10 is assembled for use. In this way, the hollow door 10 with a desired core type 18 can be powder coated on the inside and outside to reduce or prevent corrosion. Additionally, the frame and other components of the door and door assembly can be powder coated to prevent corrosion.

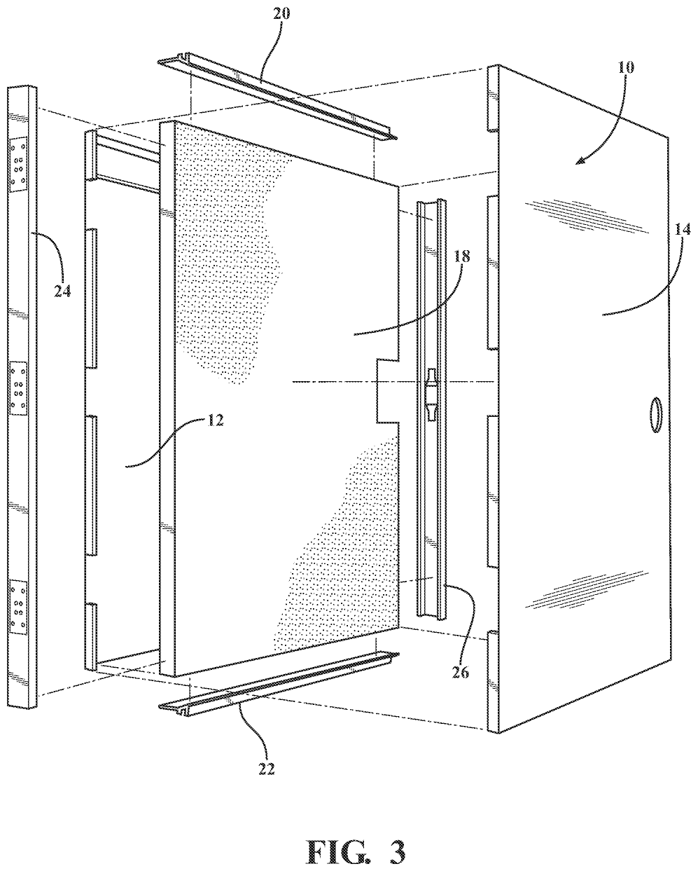

With reference to FIG. 3, a typical hollow door 10 is illustrated. The door 10 includes an exterior skin 12 and an interior door skin 14. The skins 12 and 14 are made of metal. The skins 12 and 14 are connected by a top channel 20, a bottom channel 22, a hinge channel 24 and a lock channel 26, which are disclosed at metal parts. The channels 20, 22, 24 and 26 are connected to the skins 12 and 14 by typical connections known to those of ordinary skill in the art. The core 18 is mounted within the hollow door 10. The core 18 can be one of any desired core material.

The door 10 is powder coated prior to assembly. The parts of the door 10, the skins 12 and 14, and channels 20, 22, 24 and 26 are powder coated, and in the preferred embodiment powder coated on all surfaces. Still further, if desired, the frame 16 can be powder coated.

Powder coating is a dry finishing process that provides a high-quality, durable finish. It can be used as a functional (protective) and decorative finish. Powder coatings are based on polymer resin systems, combined with curatives, pigments, leveling agents, flow modifiers, and other additives, which are well known to those of ordinary skill in the art. These ingredients are melt-mixed, cooled, and ground into a uniform powder. A process called electrostatic spray deposition (HD) is typically used to achieve the application of the powder coating to the metal substrate, i.e., the parts of the door 10 and if desired the frame 16.

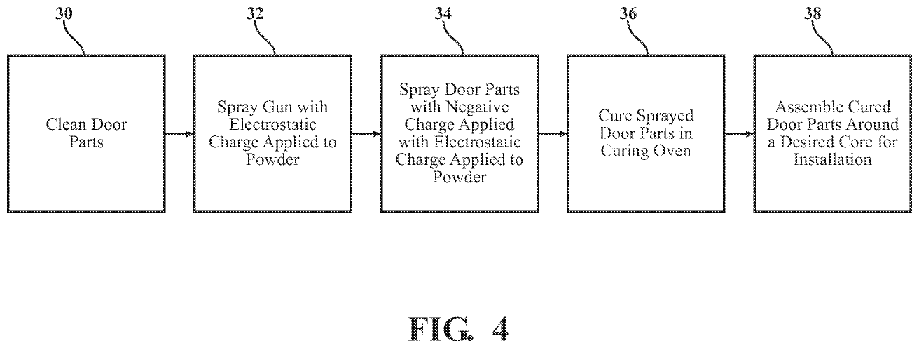

With reference to FIG. 4, the application method first includes the step of cleaning the door 10 parts at step 30. At step 32, a spray gun applies an electrostatic charge to the powder particles, which are then sprayed on the grounded parts 10 in step 34. Alternatively, the powder coating can be applied using a fluidized bed application. Preheated parts are dipped in a hopper of fluidizing powder and the coating melts and flows onto the part.

At step 36, after application of the powder coating in step 34, the parts enter a curing oven at 350-400 degrees F. This allows the electrostatically charged powder to adhere to the part. After getting up to temperature, the part is left in the oven for the cure time specified by the powder manufacturer. With the addition of heat, the coating chemically reacts to produce long molecular chains, resulting in high cross-link density. These molecular chains are very resistant to breakdown.

It will be understood by those of ordinary skill in the art that other types of powder coating are available and would be within the scope of the present invention.

After the parts of the door 10 are cured they are assembled about the desired core in step 38 creating a pre-assembled powder coated door 10.

Powder coating provides a more durable finish than liquid paints can offer, while still providing an attractive finish. Powder coated products are more resistant to diminished coating quality because of impact, moisture, chemicals, ultraviolet light, and other extreme weather conditions. In turn, this reduces the risk of scratches, chipping, abrasions, corrosion, fading, and other wear issues.

The foregoing invention has been described in accordance with the relevant legal standards, thus the description is exemplary rather than limiting in nature. Variations and modifications to the disclosed embodiment may become apparent to those skilled in the art and do come within the scope of the invention. Accordingly, the scope of legal protection afforded this invention can only be determined by studying the following claims.

We claim:

1. A method of making a metal core door comprising:
providing a core;
providing door parts including an exterior skin, an interior skin and channels;
powder coating said door parts and curing said powder coated parts;
thereafter assembling said door parts about said core to create a pre-assembled door with an interior core.

2. A method of making a metal core door comprising:
providing a core;
providing door parts including an exterior skin, an interior skin and channels;
powder coating said door parts and curing said powder coated parts;
whereby said door parts are powder coated and can be assembled about said core to create a powder coated door with an interior core.

3. A metal door comprising;
a door assembly including;
powder coated, front and back skins;
powder coated hinge and lock channels;
powder coated top and bottom channels;
a core positioned within said door assembly.
